(19) United States
(12) Patent Application Publication
(10) Pub. No.: US 2019/0347659 A1
(43) Pub. Date: Nov. 14, 2019

(54) Electronic Transaction System Having Extended Overdraft Protection

(71) Applicant: International Business Machines Corporation, Armonk, NY (US)

(72) Inventors: Michael J. Hudson, Delray Beach, FL (US); Sean Dunne, Blackrock (IE)

(21) Appl. No.: 15/978,835

(22) Filed: May 14, 2018

(51) Int. Cl. G06Q 20/40; G06Q 20/22; G06Q 40/02

(52) U.S. Cl. CPC G06Q 20/401; G06Q 40/02; G06Q 20/22

(57) ABSTRACT

An electronic system, computer-implementable method, and non-transitory, computer-readable storage medium for providing overdraft protection during an electronic financial transaction. In various examples, overdraft protection is provided by transferring funds from accounts held by an account holder at different financial institutions. In one example, transfers take place using a first real-time electronic payment system of a first financial institution and a second real-time electronic payment system of a second financial institution.

### BACKGROUND OF THE INVENTION

### Field of the Invention

The present invention relates in general to the field of computers and similar technologies, and in particular to electronic transaction systems utilized in this field. Still more particularly, it relates to a method, system and computer-usable medium for conducting electronic transactions having overdraft protection.

### Description of the Related Art

Electronic financial transactions involving transfer of funds between accounts have become ubiquitous. Such transactions occur whenever an account holder writes a check, uses a debit card, withdraws money from an ATM, and the like.

When the account holder attempts to execute a financial transaction requesting more than the holder has in their account, the transaction may be rejected, the check may bounce, and/or the account may become overdrawn. Overdrafts are expensive for account holders and are discouraged by banks.

### SUMMARY OF THE INVENTION

An electronic system, computer-implementable method, and non-transitory, computer-readable storage medium are disclosed for providing overdraft protection during an electronic financial transaction. In various examples, an account holder initiates a withdrawal of funds from a first account held at a first financial institution using a financial transaction terminal. A determination is made automatically at the first financial institution, whether the first account has an amount of funds sufficient to cover the request for withdrawal. if the first account has an amount of funds sufficient to cover the request, the first financial institution communicates with the financial transaction terminal over the electronic communication network to complete the request for withdrawal using funds from the first account. However, if the first account does not have a sufficient amount of funds to cover the request, the first financial institution communicates with a second financial institution using a first real-time electronic payment system of the first financial institution to request transfer of an amount of funds from a second account of the account holder held at the second financial institution to cover the request for withdrawal. The request for the amount of funds is received by a second real-time electronic payment system of the second financial institution. Using the first and second real-time payment systems, the requested amount of funds are transferred from the second account to the first account if the amount of funds in the second account is sufficient to cover the request for withdrawal. The first financial institution communicates with the financial transaction terminal over the electronic communication network to complete the request for withdrawal of funds using funds from the first account.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a block diagram depicting one example of an automated financial transaction system having extended overdraft protection.

FIG. 2 is a flowchart depicting one example of operations that may be executed to remotely authorize overdraft protection and establish a link between accounts at different financial institutions for that protection.

FIG. 3 is a flowchart depicting operations that may be executed when the account holder requests a withdrawal of funds from the first account.

FIG. 4 is a flowchart depicting another example of operations that may be executed when the account holder requests a withdrawal of funds from the first account.

FIG. 5 is a block diagram illustrating a network environment in which an electronic transaction system having overdraft protection may be practiced.

FIG. 6 is a block diagram showing a simplified example of a computer system that may he used in performing the computing operations described herein.

### DETAILED DESCRIPTION

A method, system and computer-usable media for performing overdraft protection are disclosed. The system may be employed when an account holder has accounts at more than one financial institution. Financial institutions are typically corporations, or other business entities, which provide services as intermediaries of financial markets. These include, for example, depository institutions that accept and manage deposits and make loans. Some of the more prevalent depository institutions include banks, building societies, credit unions, trust companies, mortgage and loan companies, etc.

Some financial institutions offer overdraft solutions to their account holders. In such systems, the financial institution may approve a transaction that overdraws the account if there are sufficient funds in another account at the same institution. However, the account holder must have multiple accounts at the same financial institution to obtain this type of overdraft protection.

Unlike other systems, the disclosed system provides overdraft protection to the account holder using accounts at different financial institutions. As such, funds from an account at one financial institution may be used to cover financial transaction amounts requested from another account at another financial institution. The transfer between the accounts at different financial institutions occurs through a real-time payment system, which allows clearance of a transfer at the time the transfer, but prior to settlement between the financial institutions. This affords the account holder with overdraft protection without having multiple accounts at the same financial institution. It should be noted, however, that the system may be used when the account holder has multiple accounts at the same financial institution, provided that the account holder also has another account in yet another financial institution.

Various aspects of the disclosure utilize a real-time or immediate payments system such as the IBM Financial Transaction Manager™ financial management system available from International Business Machines (IBM) Corporation of Armonk, N.Y. The IBM Financial Transaction Manager™ may be used to integrate, orchestrate and monitor financial transactions. It delivers consistent processing across multiple payment types, enabling banks and financial institutions to converge their payment operations on to a single platform. The IBM Financial Transaction Manager™ can accelerate the delivery of improved financial products and services to customers. It offers prebuilt, industry-standard capabilities with optional complementary products for Immediate Payments, SWIFT, ACK SEPA, check processing and corporate payment services.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “system.” Furthermore, aspects of the present invention may take the form of a computer program product embodied in one or more computer-readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

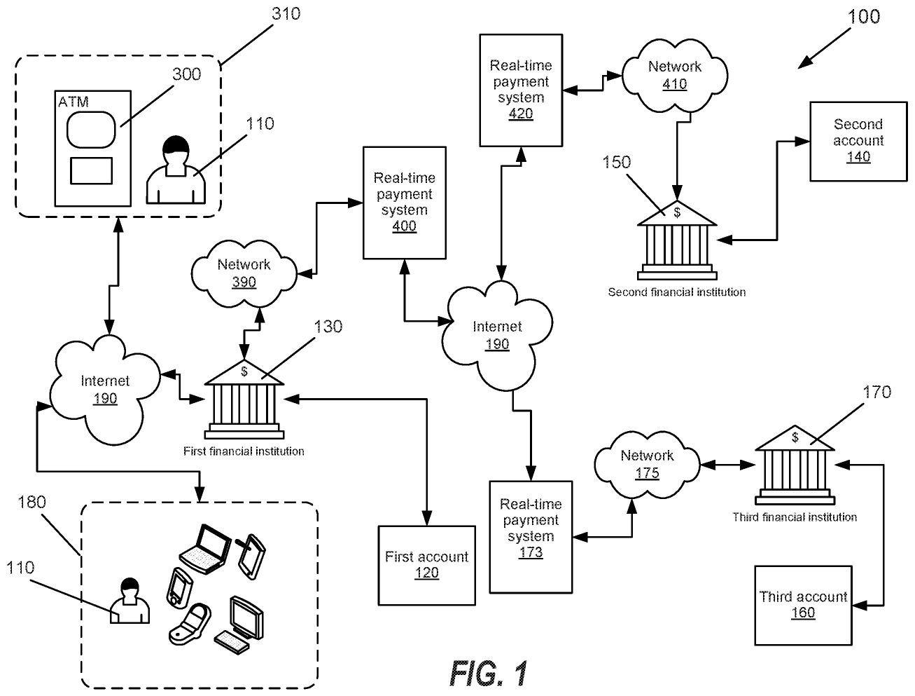

FIG. 1 is a block diagram depicting one example of an automated financial transaction system 100 having extended overdraft protection. In this example, an account holder 110 holds a first account 120 at a first financial institution 130. The account holder 110 also has a second account 140 at a second financial institution 150 and may have a third account 160 at a third financial institution 170. The account holder 110 may also have multiple accounts at each of the financial institutions 130, 150, and 170. Other combinations of multiple accounts at multiple financial institutions may also be used.

As depicted at block 180, the account holder 110 may access the first financial institution 130 using one or more mobile devices over a network, such as the Internet 190. In one example, the account holder 110 uses such remote access to authorize overdraft protection and establish a link with one or more accounts (e.g., accounts 140 and/or 160) at different financial institutions (e.g. financial institutions 150 and/or 170). Additionally, or in the alternative, authorization of overdraft protection and establishing such links may take place in person by the account holder at the financial institution 130 (e.g., bank branch, or the like).

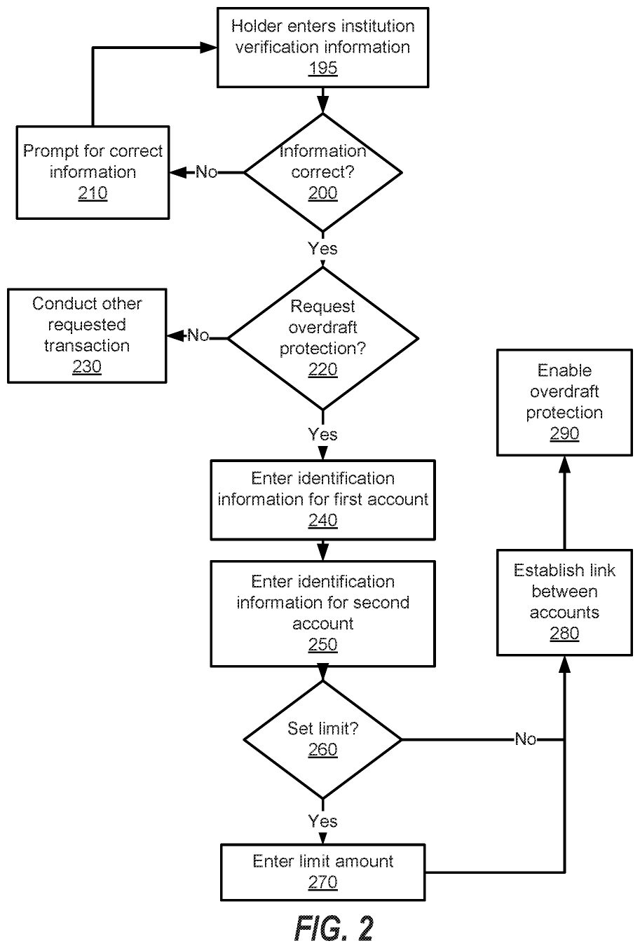

FIG. 2 is a flowchart depicting one example of operations that may be executed by the system 100 to remotely authorize overdraft protection and establish a link between accounts at different financial institutions for that protection. Here, at operation 195, the account holder 110 enters verification information using, for example, one or more mobile devices, to access the first account 120. A check is made at operation 200 to determine whether the information is correct. If not, the account holder 110 may be re-prompted for the correct information at operation 210. The financial institution 130 may limit the number of attempts to enter the information before the account is locked from further access.

At operation 220, the system 100 checks to determine whether the account holder 110 is requesting overdraft protection. If not, a different transaction requested by the holder 110 is executed at operation 230. However, if overdraft protection is to be enabled, the account holder enters the identification information for the first account 120 at operation 240 and identification information for the second account 140 (and/or third account 160) at operation 250. The account holder 110 may request a limit on the amount of funds that may be transferred to the first account from accounts at the other financial institutions at operation 260. If a limit is to be imposed, the account holder 110 enters the limit amount at operation 270 and the system 100 establishes a link between the first and second accounts 120, 140 at operation 280. If no limit is to be imposed, the system 1.00 may proceed directly to operation 280. Establishing the link between accounts at operation 280 is typically completed over the span of one or more days and may take place using communications between the financial institutions over the Internet 190. With the link between accounts established, overdraft protection for the first account 120 at the first financial institution 130 is enabled at operation 290.

The account holder 110 may execute any number of different financial transaction types in which overdraft protection is invoked. In the example shown in FIG. 1, the account holder 110 is shown conducting a transaction at an ATM 300 at block 310.

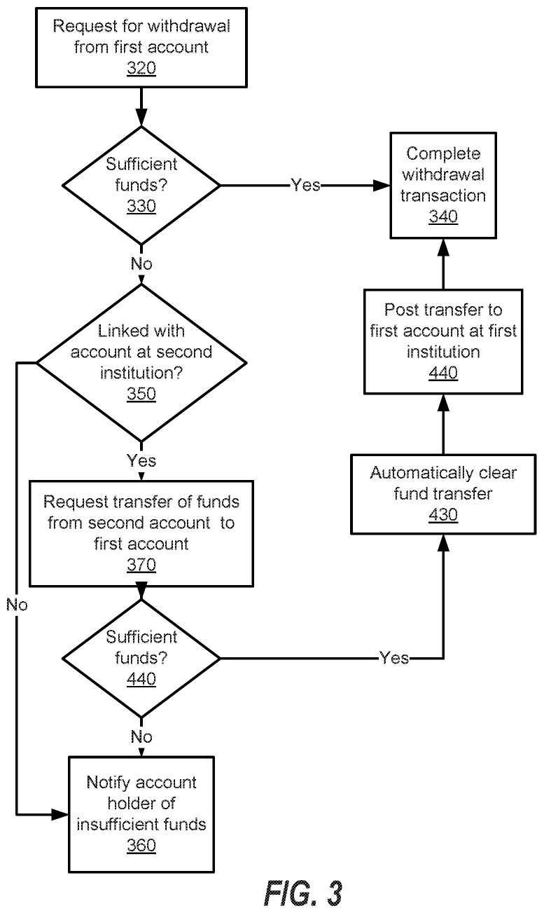

FIG. 3 is a flowchart depicting operations that may be executed by system 100 when the account holder 110 requests a withdrawal of funds from the first account 120 using the ATM 300. In this example, the account holder 110 makes a request for withdrawal from the first count at operation 320. The system 100 checks to determine whether there are sufficient funds in the first account to cover the amount of the requested withdrawal at operation 330. If sufficient funds are present, the transaction is completed at operation 340.

If the first account 120 does not have sufficient funds, the system 100 determines whether the first account is linked with an account at another financial institution, such as second financial institution 150, or third institution 170. This determination is made at operation 350. If there is no link to another account to prevent an overdraft, the account holder is notified at operation 360 of this fact. If a determination is made at operation 350 that the first account 120 is linked to, for example, the second account 140 at the second financial institution 150, a request for transfer of funds from the second account 140 to the first account 120 is made at operation 370.

With reference to FIG. 1, for purposes of the request for withdrawal, the first financial institution 130 and second financial institution 150 communicate with one another using a real-time payment system architecture. In this example, network 390 may include a real-time payment system 400 associated with the first financial institution 130. Similarly, network 410 may include a real-time payment system 420 associated with the second financial institution 150. The real-time payment systems 400 and 420 may communicate with one another over the Internet 190. Similarly, if the account holder 110 has third account 160, the third financial institution 170 conducts financial transactions with the first financial institution 130 over a network 175 using real-time payment system 173. Communication with other real-time payment systems may occur over, for example, the Internet 190.

Fund transfers using real-time payment systems 400 and 420 (a.k.a., immediate payment system, etc.) differ from conventional fund transfers between financial institutions. In conventional fund transfers, settlement occurs between the institutions before the requested funds are transferred. It is only after settlement that the receiving institution, such as financial institution 130, has irrevocable access to the funds requested from the second financial institution 150. Settlement, however, typically requires hours and/or days to complete. As such, conventional fund transfer systems are not suitable for providing a short-term response to prevent an overdraft from, for example, the first account 120.

In contrast, real-time payment systems 400 and 420 communicate with one another using a real-time payment communications standard, such as ISO 20022. ISO 20022 is an ISO standard for electronic data interchange between financial institutions. It describes a metadata repository containing descriptions of messages and business processes, and a maintenance process for the repository content. The standard covers financial information transferred between financial institutions that includes payment transactions, securities trading and settlement information, credit and debit card transactions, and other financial information. Using such real-time payment systems 400 and 420, it is possible to execute a transfer of funds from the second account 140 at the second financial institution 150 to the first account 120 at the first financial institution 130 in, for example, less than five seconds end-to-end. In such systems, funds are transferred promptly once they are cleared and the account holder need not wait for settlement between the financial institutions before transfer.

With reference to operation 440 of FIG. 3, the system 100 checks to determine whether there are sufficient funds in the second account 140 to cover the amount of the withdrawal requested by the account holder 110. The amount of funds required to cover the transfer may be determined in a number of different manners. In one example, the entire amount of the requested withdrawal will be used for the transaction. To this end, the entire amount of the request will be checked against the amount of funds available in the second account 140 at operation 440. Compared to the amount available in the second account 140. In another example, all or a portion of the funds available in the first account 120 are used for the financial transaction. In such instances, operation 440 compares the amount of the requested funds against the difference between the funds available from the first account 120 and the funds available from the second account 140. The amount of funds transferred from the second account 140, therefore, only supplements the amount available from the first account 120 to cover the requested withdrawal. These choices may be set by the financial institutions 130 and/or 150 or set as an option by the account holder 110.

If there are insufficient funds in the second account 140, and only a single account is linked with the first account 120, the transaction will be rejected. The account holder 110 may be notified that the funds at the second account 140 were insufficient to cover the requested withdrawal at operation 360. Such notifications may occur, for example, at a user interface at the ATM 300.

If there are sufficient funds in the second account 140, clearance for the fund transfer is given at operation 430 and the transfer is posted to the first account 120 at operation 440. This may automatically occur if sufficient funds are found at operation 440. Alternatively, the account holder 110 may be prompted for authorization to transfer the funds from the second account 140 to the first account 120 before clearance for the fund transfer is given at operation 430. Automatic clearance for transfer is shown in FIG. 3. All funds necessary to complete the request for withdrawal initiated at operation 320 are then available in the first account 120 and the transaction is completed at operation 340. Clearance and posting using real-time payment systems generally makes the total amount of the funds needed for the withdrawal available in the short amount of time that the account holder 110 spends at the ATM 300, with ultimate settlement between the financial institutions 130 and 150 deterred until a later time.

In one example, the IBM Financial Transaction Manager™ may be used to integrate, orchestrate and monitor the financial transactions executed by the real-time payment systems 400 and 420.

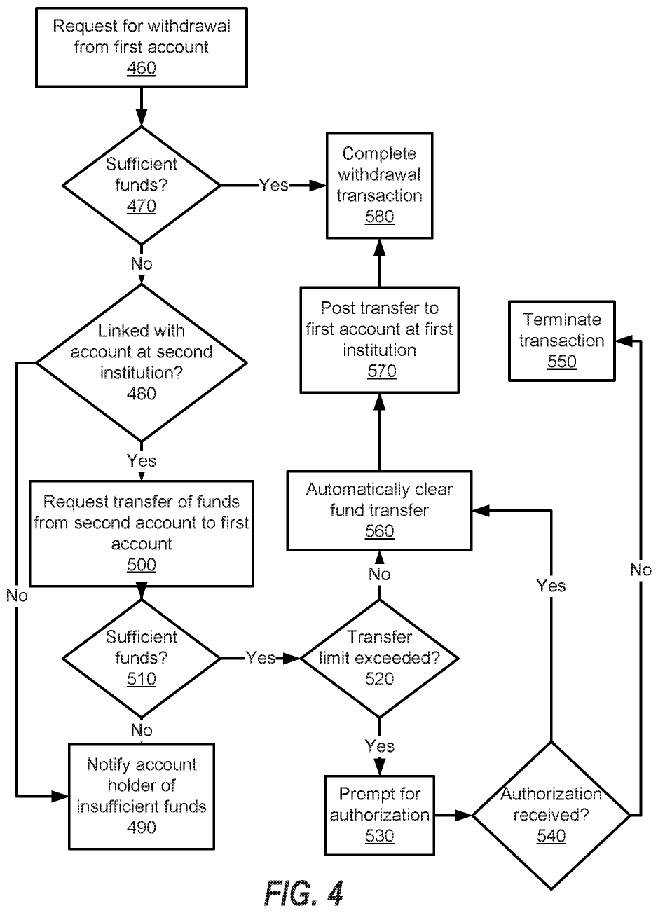

FIG. 4 is a flowchart depicting another example of operations that may be executed by system 100 when the account holder 110 requests a withdrawal of funds from the first account 120 using the ATM 300. In this example, the account holder 110 makes a request for withdrawal from the first account 120 at operation 460. The system 100 checks whether there are sufficient funds in the first account to cover the amount of the requested withdrawal at operation 470. If sufficient funds are present, the transaction is completed at operation 480. If the first account 120 does not have sufficient funds, the system 100 determines whether the first account 120 is linked with an account at another financial institution, such as the second financial institution 150 or third financial institution 170. This determination is made at operation 480. If there is no link to another account to prevent an overdraft, the account holder is notified at operation 490 of this fact. If a determination is made at operation 480 that the first account 120 is linked, for example, to the second account 140 at the second financial institution 150, a request for transfer of funds from the second account to the first account is made at operation 500.

With reference to operation 510 of FIG. 4, the system 100 checks to determine whether there are sufficient funds in the second account 140 to cover the amount of the withdrawal requested by the account holder 110. As above, the amount of funds required to cover the transfer may be determined in a number of different manners.

If there are insufficient funds in the second account 140, and only a single account is linked with the first account 120, the transaction will be rejected. The account holder 110 may be notified that the funds at the second account 140 were insufficient to cover the requested withdrawal at operation 490. Such notifications may occur, for example, at a user interface of the ATM 300.

If there are sufficient funds in the second account 140, a further check is made at operation 520 to determine whether the amount required from the second account 140 to cover the requested withdrawal is greater than a transfer limit amount set by either the account holder 110 and/or financial institutions 130, 150. If the transfer limit amount has been set up by the account holder 110, the system 100 may prompt the account holder 110 at operation 530 for authorization to exceed the transfer limit. In one example, the authorization is requested through the user interface of the ATM 300. If the account holder 110 does not authorize the override of the fund transfer limit at operation 540, the transaction is terminated at operation 550. If, on the other hand, the user provides authorization at operation 540, the transfer of the funds from the second account 140 to the first account 120 is cleared at operation 560 and posted for use at the first institution at operation 570. All funds necessary to complete the request for withdrawal initiated at operation 460 are then available in the first account 120 and the requested withdrawal is completed at operation 580. As above, clearance generally makes the total amount of the funds needed for the withdrawal available in the short amount of time that the account holder 110 spends at the ATM 300, with ultimate settlement between the financial institutions 130 and 150 deferred until a later time.

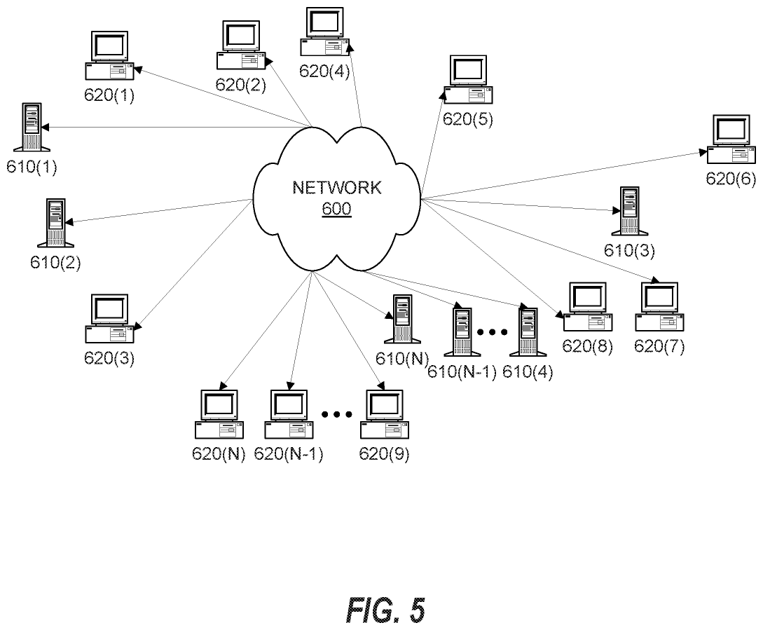

FIG. 5 is a block diagram illustrating a network environment in which an electronic transaction system having overdraft protection may be practiced. Network 600 (e.g. a private WAN or the Internet includes a number of networked server computer systems 610(1)-(N) that are accessible by client computer systems 620(1)-(N), where N is the number of server computer systems connected to the network. Communication between client computer systems 610(1)-(N) and server computer systems 610(1)-(N) typically occurs over a network, such as a public switched telephone network over asynchronous digital subscriber line (ADSL) telephone lines or high-bandwidth trunks, for example communications channels providing T1 or OC3 service. Client computer systems 620(1)-(N) typically access server computer systems 610(1)-(N) through a service provider, such as an internee service provider (“ISP”) by executing application specific software, commonly referred to as a browser, on one of client computer systems 620(1)-(N).

Client computer systems 620(1)-(N) and/or server computer systems 610(1)-(N) may be, for example, computer systems of any appropriate design, including a mainframe, a mini-computer, a personal computer system including notebook computers, a wireless, mobile computing device (including personal digital assistants, smart phones, and tablet computers). When programmed to implement at least one embodiment of the system extended for performing source code analysis, the computer systems are specialized machines. These computer systems are typically information handling systems, which are designed to provide computing power to one or more users, either locally or remotely. Such a computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the system for overdraft protection can be implemented using code stored in a tangible, non-transient computer readable medium and executed by one or more processors,

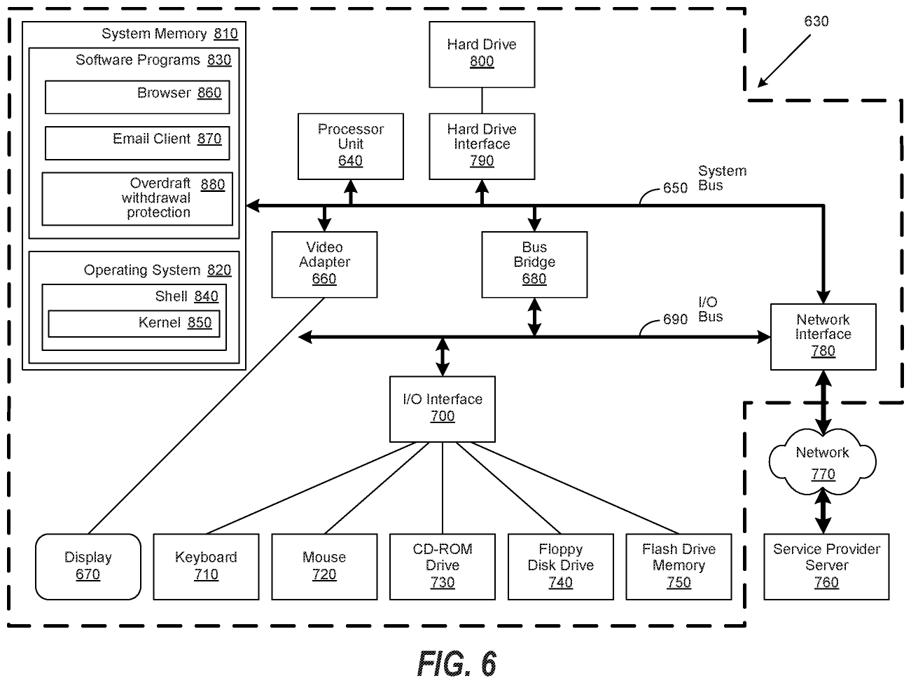

FIG. 6 is a block diagram showing a simplified example of a computer system 630 that may be used in performing the computing operations described herein. In one example, the architecture of the computer system 630 may be used to implement the server computer systems 610 and/or client computer systems 620 shown in FIG. 5.

Computer system 630 includes a processor unit 640 that is coupled to a system bus 650. A video adapter 660, which controls a display 670, is also coupled to system bus 650. System bus 650 is coupled via a bus bridge 680 to an Input/Output (I/O) bus 690. An I/O interface 700 is coupled to I/O bus 690. The I/O interface 700 affords communication with various I/O devices, including a keyboard 710, a mouse 720, a (CD-ROM) drive 730, a floppy disk drive 740, and a flash drive memory 750. The format of the ports connected to I/O interface 700 may be any known to those skilled in the art of computer architecture, including but not limited to Universal Serial Bus (USB) ports.

The computer system 630 can communicate with a service provider server 760 via a network 770 using a network interface 780, which is coupled to system bus 650. Network 770 may be an external network such as the Internet, or an internal network such as an Ethernet Network or a Virtual Private Network (VPN). Using network 770, computer systems 630 can access one or more service provider servers 760.

A hard drive interface 790 is also coupled to system bus 650. Hard drive interface 790 interfaces with a hard drive 800. In one example, hard drive 800 populates a system memory 810, which is also coupled to system bus 650. Data that populates system memory 810 includes the computer system's 650 operating system (OS) 820 and software programs 830.

OS 820 includes a shell 840 for providing transparent user access to resources such as software programs 830. Generally, shell 840 is a program that provides an interpreter and an interface between the user and the operating system. More specifically, shell 840 executes commands that are entered into a command line user interface or from a file. Thus, shell 840 (as it is called in UNIX®), also called a command processor in Windows®, is generally the highest level of the operating system software hierarchy and serves as a command interpreter. The shell 840 provides a system prompt, interprets commands entered by keyboard, mouse, or other user input media, and sends the interpreted command(s) to the appropriate lower levels of the operating system (e.g., a kernel 850) for processing. While shell 840 generally is a text-based, line-oriented user interface, the present invention can also support other user interface modes, such as graphical, voice, gestural, etc.

As depicted, OS 820 also includes kernel 850, which includes lower levels of functionality for OS 820, including essential services required by other parts of OS 820 and software programs 830, including memory management, process and task management, disk management, and mouse and keyboard management. Software programs 830 may include a browser 860 and email client 870. Browser 860 includes program modules and instructions enabling a World Wide Web (WWW) client (i.e., computer system 630) to send and receive network messages to the Internet using HyperText Transfer Protocol (HTTP) messaging, thus enabling communication with service provider server 760. In various embodiments, software programs 830 may also include overdraft protection code 880, which includes code for implementing the processes described above. In one embodiment, the computer system 630 can download the overdraft protection code 880 from a service provider server 760.

The hardware elements depicted in the computer system 630 are not intended to be exhaustive, but rather are representative to highlight components used by the present invention. For instance, the computer system 630 may include alternate memory storage devices such as magnetic cassettes, DVDs, Bernoulli cartridges, and the like. These and other variations are intended to be within the spilt scope and intent of the present invention.

Although embodiments have been described in detail, it should be understood that various changes, substitutions, and alterations can be made hereto without departing from the spirit and scope of the invention as defined by the appended claims.

What is claimed is:

1. A computer-implementable method for overdraft protection during an electronic financial transaction, comprising:
initiating, by an account holder at a financial transaction terminal, a request for withdrawal of funds from a first account of the account holder held at a first financial institution;
communicating the request for withdrawal of funds from the financial transaction terminal to the first financial institution over an electronic communication network;
automatically determining, at the first financial institution, whether the first account has an amount of funds sufficient to cover the request for withdrawal;
if the first account has an amount of funds sufficient to cover the request for withdrawal, communicating with the financial transaction terminal over the electronic communication network to complete the request for withdrawal using funds from the first account;
if the first account does not have a sufficient amount of funds to cover the request for withdrawal, communicating with a second financial institution using a first real-time electronic payment system of the first financial institution to request transfer of an amount of funds from a second account of the account holder held at the second financial institution to cover the request for withdrawal, wherein the request for the amount of funds is received by a second real-time electronic payment system of the second financial institution;
transferring, using the first and second real-time payment systems, the requested amount of funds from the second account to the first account if the amount of funds in the second account is sufficient to cover the request for withdrawal; and
communicating with the financial transaction terminal over the electronic communication network to complete the request for withdrawal of funds using funds from the first account.

2. The computer-implementable method of claim 1, wherein the first and second real-time electronic payment systems provide communication between the first financial institution and the second financial institution over a network using electronic messaging conforming to a real-time-payments communication standard.

3. The computer-implementable method of claim 1, wherein the amount of funds transferred from the second account is less than a total amount of funds withdrawn at the financial transaction terminal.

4. The computer-implementable method of claim 1, wherein the transfer of funds from the second account to the first account occurs automatically if the second account has a sufficient amount of funds to cover the request for withdrawal.

5. The computer-implementable method of claim 1, further comprising:
prompting the account holder at the financial transaction terminal for authorization to transfer funds from the second account to the first account during the request for withdrawal of funds if the first account does not have sufficient funds to cover the request for withdrawal; and
transferring, using the first and second real-time electronic payment systems, the funds from the second account to the first account if the account holder authorizes transfer in response to the prompting.

6. The computer-implementable method of claim 1, further comprising, prior to receiving the request for transfer, establishing a link between the first account at the first financial institution and the second account at the second financial institution to prevent an overdraft of the first account, wherein establishing the link comprises:
verifying, by the first financial institution, electronic account login information received from the account holder received over a network;
receiving, from the account holder over the network, a request for overdraft protection of the first account, wherein the request for overdraft protection includes
identification information for the first account;
identification information for the second account; and
information corresponding to limits, if any, on an amount of funds that may be transferred from the second account to the first account.

7. The computer-implementable method of claim 1, further comprising:
if the second account does not have a sufficient amount of funds to cover the amount of funds requested for transfer, using the first real-time electronic payment system to transfer an amount of funds from a third account of the account holder at a third financial institution to the first account to cover the amount of funds requested by the account holder, wherein the transfer from the third account uses a third real-time electronic payment system of the third financial institution.

8. A system comprising:
one or more processors;
computer-readable storage embodying computer program code that is executable by the one or more processors, the computer program code configured for execution by the one or more processors to:
initiate, by an account holder at a financial transaction terminal, a request for withdrawal of funds from a first account of the account holder held at a first financial institution;
communicate the request for withdrawal of funds from the financial transaction terminal to the first financial institution over an electronic communication network;
automatically determine, at the first financial institution, whether the first account has an amount of funds sufficient to cover the request for withdrawal;
if the first account he has an amount of funds sufficient to cover the request for withdrawal, communicate with the financial transaction terminal over the electronic communication network to complete the request for withdrawal using funds from the first account;
if the first account does not have a sufficient amount of funds to cover the request for withdrawal, communicate with a second financial institution using a first real-time electronic payment system of the first financial institution to request transfer of an amount of funds from a second account of the, holder held at the second financial institution to cover the request for withdrawal wherein the request for the amount of funds is received by a second real-time electronic payment system of the second financial institution;
transfer, using the first and second real-time payment systems, the requested amount of funds from the second account to the first account if the amount of funds in the second account is sufficient to cover the request for withdrawal; and
communicating with the financial transaction terminal over the electronic communication network to complete the request for withdrawal of funds using funds from the first account.

9. The system of claim 8, wherein the first and second real-time electronic payment systems provide communication between the first financial institution and the second financial institution over a network using electronic messaging conforming to a real-time-payments communication standard.

10. The system of claim 8, wherein the computer program code is configured to transfer an amount of funds from the second account that is less than a total amount of funds withdrawn at the financial transaction terminal.

11. The system of claim 8, wherein the computer program code is configured to transfer funds from the second account to the first account automatically if the second account has a sufficient amount of funds to cover the request fur withdrawal.

12. The system of claim 8, wherein the computer program code is further configured to:
prompt the account holder, at the financial transaction terminal, for authorization to transfer funds from the second account to the first account during the request for withdrawal of funds if the first account does not have sufficient funds to cover the request for withdrawal; and
if the account holder authorizes the transfer in response to the prompt, transfer the funds from the second account to the first account using the first and second real-time electronic payment systems.

13. The system of claim 8, wherein the computer program code is further configured to:
establish a link between the first account at the first financial institution and the second account at the second financial institution to prevent an overdraft of the first account, wherein the link is established prior to the request for withdrawal, wherein establishing the link comprises:
verifying, by the first financial institution, electronic account login information from the account holder received over a network;
receiving from the account holder over the network a request for overdraft protection of the first account, wherein the request for overdraft protection includes
identification information for the first account;
identification information for the second account; and
information corresponding to limits, if any, on an amount of funds that may be transferred from the second account to the first account.

14. The system of claim 8, wherein the computer program code is further configured to:
if the second account does not have a sufficient amount of funds to cover the amount of funds requested for transfer, use the first and second real-time electronic payment systems to transfer an amount of funds from a third account of the account holder at a third financial institution to the first account to cover the request for withdrawal wherein the transfer from the third account uses a third real-time electronic payment system of the third financial institution.

15. A non-transitory, computer-readable storage medium embodying computer program code, the computer program code comprising computer executable instructions configured for:
initiating, by an account holder at a financial transaction terminal, a request for withdrawal of funds from a first account of the account holder held at a first financial institution;
communicating the request for withdrawal of funds from the financial transaction terminal to the first financial institution over an electronic communication network;
automatically determining, at the first financial institution, whether the first account has an amount of funds sufficient to cover the request for withdrawal;
if the first account has an amount of funds sufficient to cover the request for withdrawal, communicating with the financial transaction terminal over the electronic communication network to complete the request for withdrawal using funds from the first account;
if the first account does not have a sufficient amount of funds to cover the request for withdrawal, communicating with a second financial institution using a first real-time electronic payment system of the first financial institution to request transfer of an amount of funds from a second account of the account holder held at the second financial institution to cover the request for withdrawal, wherein the request for the amount of funds is received by a second real-time electronic payment system of the second financial institution;
transferring, using the first and second real-time payment systems, the requested amount of funds from the second account to the first account if the amount of funds in the second account is sufficient to cover the request for withdrawal; and
communicating with the financial transaction terminal over the electronic communication network to complete the request for withdrawal of funds using funds from the first account.

16. The non-transitory, computer-readable storage medium of claim 15, wherein the computer executable instructions are further configured to provide communication between the first and second real-time electronic payment systems using messaging conforming to a real-time-payments communication standard.

17. The non-transitory, computer-readable storage medium of claim 15, wherein the computer executable instructions are further configured to transfer an amount of funds from the second account to the first account that is less than a total amount of funds withdrawn at the financial transaction terminal.

18. The non-transitory, computer-readable storage medium of claim 15, wherein the computer executable instructions are further configured for transferring funds from the second account to the first account automatically if the second account has a sufficient amount of funds to cover the request for withdrawal.

19. The non-transitory, computer-readable storage medium of claim 15, wherein the computer executable instructions are further configured for:
prompting, at the financial transaction terminal, the account holder for authorization to transfer funds from the second account to the first account during the request for withdrawal of funds if the first account does not have sufficient funds to cover the request for withdrawal; and
transferring, using the first and second electronic payment systems, the funds from the second account to the first account if the account holder authorizes transfer in response to the prompting.

20. The non-transitory, computer-readable storage medium of claim 15, wherein the computer executable instructions are further configured for:
if the second account does not have a sufficient amount of funds to cover the amount of funds requested for transfer, using the first real-time electronic payment system to transfer an amount of funds from a third account of the account holder at a third financial institution to the first account to cover the amount of funds requested by the account holder, wherein the transfer from the third account uses a third real-time electronic payment system of the third financial institution.
